(19) United States
(12) Patent Application Publication
(10) Pub. No.: US 2015/0226090 A1
(43) Pub. Date: Aug. 13, 2015

(54) GAS AND STEAM TURBINE SYSTEM HAVING FEED-WATER PARTIAL-FLOW DEGASSER

(71) Applicant: SIEMENS AKTIENGESELLSCHAFT, München (DE)

(72) Inventors: Erich Schmid, Nurnberg (DE); Michael Schöttler, Erlangen (DE); Helmut Stierstorfer, Erlangen (DE); Anke Söllner, Bubenreuth (DE)

(21) Appl. No.: 14/430,370

(22) PCT Filed: Sep. 11, 2013
(86) PCT No.: PCT/EP2013/068787

§ 371 Date: Mar. 23, 2015

(30) Foreign Application Priority Data
Sep. 27, 2012 (DE) 10 2012 217 514.8

(51) Int. Cl. F01K 23/10; C02F 1/20; F01K 7/16

(52) U.S. Cl. CPC F01K 23/10; F01K 7/16; C02F 1/20; C02F 2103/02

(57) ABSTRACT

A method for operating a gas and steam turbine system, in which, in an associated waste-heat steam generator, the heat contained in the expanded working medium of an associated gas turbine is utilized for the generation of steam for an associated steam turbine with at least one low-pressure part and one high-pressure part, the low-pressure part being assigned in the waste-heat steam generator a low-pressure stage with a low-pressure drum, gases dissolved in the water or steam being degassed essentially of steam for the low-pressure part from the low-pressure drum, and, to regulate degassing, steam production in the low-pressure drum being varied in that heat is displaced inside the waste-heat steam generator, the heat in the waste-heat steam generator being displaced in that less heat is extracted from the working medium in a medium-pressure stage or high-pressure stage of the gas and steam turbine system.

### CROSS-REFERENCE TO RELATED APPLICATIONS

This application claims priority to PCT Application No. PCT/EP2013/068787, having a filing date of Sep. 11, 2013, based off of DE 102012217514.8 having a filing date of Sep. 27, 2012, the entire contents of which are hereby incorporated by reference.

### FIELD OF TECHNOLOGY

The following relates to a method for operating a gas and steam turbine system, particularly to a method for degassing the feed water, and refers to a partial-flow degassing at the low-pressure steam drum.

### BACKGROUND

To produce the required hydrochemical properties in a water/steam circuit of a steam power plant, it is necessary to remove from the circuit the noncondensable gases, such as, for example, oxygen or carbon dioxide, which are dissolved in the water or steam.

As a rule, oxygen and inert gases are degassed in the turbine condenser, insofar as the latter has been designed and is suitable for this purpose. Ammonia is often metered into the water/steam circuit for the purpose of alkalization (pH value >7). As a result, the CO₂ is present as ammonium carbonate and can be degassed (thermal break-up of the chemical compound) only at a temperature of above 135° C.

In the steam power plant, the feed-water tank, as it is known, is often also equipped with degassing at higher temperatures. Where gas and steam turbine systems are concerned, there is often no feed-water tank, but instead frequently a secondary-flow degasser. Alternatively, an enlarged low-pressure steam drum assumes the function of the feed-water tank, the entire feed water being conveyed into it (what is known as full-flow feed-water tank). The low-pressure drum then acquires a feed-water degasser, solutions also being known in which the degasser is placed on the low-pressure drum (what is known as an integral degasser).

However, there are also connections with condensate and feed-water pumps in series (what is known as a booster connection). If additional CO₂ degassing is required, bypass or secondary-flow degassers, as they are known, are employed. This degassing with about 50% to a maximum of 100% capacity is usually operated only temporarily, for example during starting or in the event of faults, specifically until the desired hydrochemical values are reached. Degassing can then be switched off again. The degassed feed water is conveyed out of the degasser back into the feed-water system via a pump.

The devices mentioned and the corresponding methods require additional outlay in terms of plant and increase the complexity of the system.

### SUMMARY

An aspect relates to further developing the method mentioned, so that the outlay for degassing is low and the systems are simple to operate.

In such a method for operating a gas and steam turbine system, in which, in an associated waste-heat steam generator, the heat contained in the expanded working medium of an associated gas turbine is utilized for generating steam for an associated steam turbine having at least one low-pressure part and one high-pressure part, the low-pressure part being assigned in the waste-heat steam generator a low-pressure stage with a low-pressure drum, gases dissolved in the water or steam are degassed essentially of steam for the low-pressure part from the low-pressure drum and, to regulate the degassing, steam production in the low-pressure drum is varied in that heat is displaced inside the waste-heat steam generator in that less heat is extracted from the working medium in a medium-pressure stage (42) or high-pressure stage (22) of the gas and steam turbine system (1).

Embodiments of the invention are therefore based on the idea of arranging in the feed-water stream to the low-pressure drum a degasser which, however, is not dimensioned for the entire feed-water stream, but only for the low-pressure steam quantity or low-pressure feed-water quantity, that is to say for a substantially smaller quantity than in the case of the enlarged low-pressure drum into which the entire feed water is conveyed. For the controlled increase in steam production of the low-pressure evaporator, the heat in the waste-heat steam generator is displaced in that less heat is extracted from the working medium in a medium-pressure stage or high-pressure stage of the gas and steam turbine system, with the result that more heat can be transferred in the low-pressure stage. The result of this is that, during degassing operation, a higher capacity of the degassing system can be achieved, for example up to or more than 20% in the case of the 3-pressure/intermediate superheater system.

Expediently, only a steam quantity required for the low-pressure part of the steam turbine is degassed.

Advantageously, less than 30%, preferably less than 20%, of a steam quantity produced in the gas and steam turbine system is degassed. As a rule, in a 3-pressure/intermediate superheater system, the quantity lies in the order of magnitude of approximately 10% of the entire condensate quantity or of the entire generated steam quantity.

The reduction in the extraction of heat in a medium-pressure or high-pressure stage of the gas and steam turbine system expediently takes place by opening a feed-water preheater bypass line in the medium-pressure or high-pressure stage.

Switching degassing operation on and off expediently takes place by regulating the temperature of the low-pressure feed water, that is to say by admixing cold condensate from the condensate preheater bypass line into the condensate preheated in the condensate preheater.

The gas and steam turbine system required for carrying out the method comprises a gas turbine, a waste-heat steam generator, following the gas turbine on the smoke gas side, for generating steam for an associated steam turbine, the waste-heat steam generator comprising at least one low-pressure stage with a low-pressure drum and one high-pressure stage, a condenser which follows the steam turbine and from which branches off a condensate line which is connected to two parallel-connected condensate branch lines, a first condensate branch line for supplying condensate to the low-pressure drum and a second condensate branch line for supplying condensate to a feed-water pump which is connected on the pressure side into the high-pressure stage, and a degasser which is connected into or to the first condensate branch line.

The arrangement of the degasser will in this case also take place in integrated form, that is to say the degasser may be connected firmly to the low-pressure drum, for example be placed on it, but may also be constructed as a separate tank next to the low-pressure drum.

In this case, the degasser is dimensioned for a low-pressure steam quantity, so that, in contrast to the system initially mentioned, the low-pressure drum does not have to be dimensioned larger than is necessary for the low-pressure stage.

The first and the second condensate branch line are connected to the condensate line via a condensate preheater arranged in the waste-heat steam generator and via a condensate preheater bypass line.

A feed-water preheater assigned to the high-pressure stage is assigned a feed-water preheater bypass line.

A feed-water preheater assigned to a medium-pressure stage is assigned a feed-water preheater bypass line.

Adjustable valves are connected into the feed-water preheater bypass lines.

By means of embodiments of the present invention, the solution of what is known as integral degasser connection on the low-pressure drum is abandoned for a solution which requires a substantially lower outlay in terms of plant, since in this case the low-pressure drum is supplied only with the low-pressure feed water for the low-pressure steam production, that is to say only a part stream of the water quantity of the overall system.

So that the magnitude of this part stream remains regulatable and therefore the degassing time can be varied, the heating of the low-pressure evaporator is varied by the displacement of heat inside the waste-heat steam generator.

Consequently, in startup operation, when there is a low power plant output, a relatively large part stream of the overall feed-water stream can be degassed at high temperature (in particular, CO₂), the outlay in terms of plant being comparatively low and operational complexity being kept within limits.

By means of embodiments of this invention, a known and serious disadvantage of the widespread connection with low-pressure drum as a full-flow feed-water degasser and with feed pumps for the medium-pressure and high-pressure part, which are supplied from the low-pressure drum, is eliminated entirely. This is because the result of this connection variant was that a concentration of impurities occurred in the low-pressure drum and automatically impaired the feed-water quality of the medium-pressure and high-pressure stage. In particular, in this case, the high-pressure fresh steam or the intermediate superheater steam was inadmissibly contaminated with poor feed-water quality when one of the high-pressure or intermediate superheater injection coolers supplied with this feed water was operated to regulate temperature.

Furthermore, by virtue of embodiments of the present invention, for example in a 2+1 connection, in which two gas turbines are connected to one steam turbine, there is the possibility of joint feed-water pumps in which three pumps, each with a 50% pumping capacity, ensure redundant operation.

The investment costs are therefore lower than in the connection with a low-pressure drum as a full-flow feed-water degasser, in which a dedicated set of feed-water pumps is required in each case per low-pressure drum.

### BRIEF DESCRIPTION

Some of the embodiments will be described in detail, with reference to the following figures, wherein like designations denote like members, wherein:

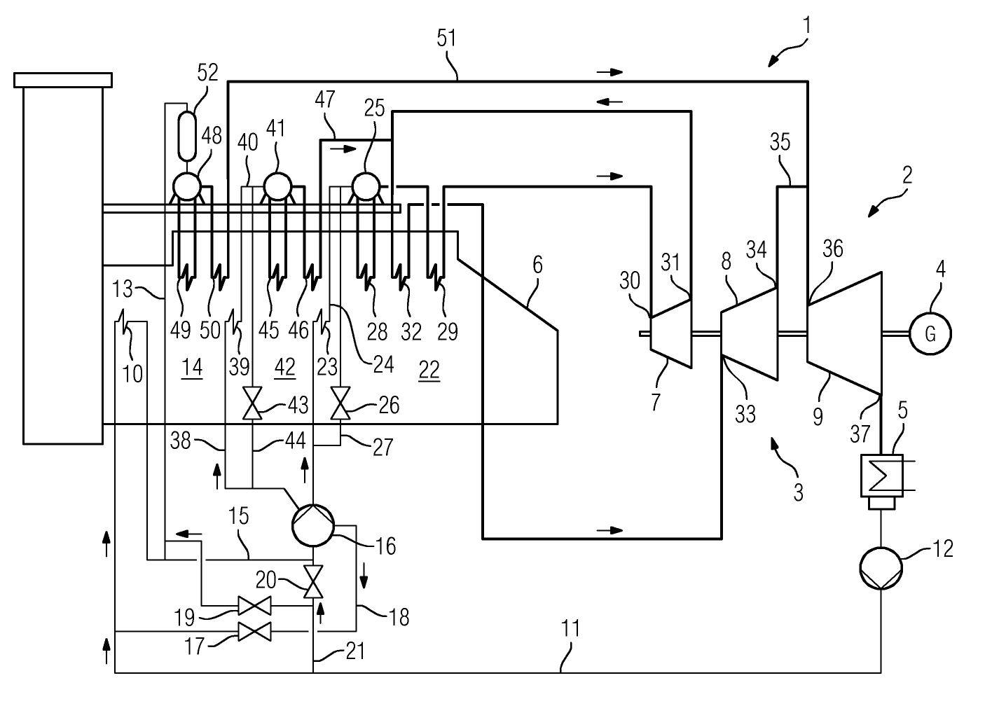

FIG. 1 illustrates an embodiment of a water/steam circuit of a combined gas and steam turbine system.

### DETAILED DESCRIPTION

The FIG. 1 shows a water/steam circuit of a combined gas and steam turbine system 1 in a diagrammatical illustration. It shows only the steam turbine system 2 of the combined gas and steam turbine system 1. The gas turbine system is omitted for the sake of greater clarity. The steam turbine system 2 comprises a steam turbine 3 with a coupled generator 4 and with a condenser 5 following the steam turbine 3 and also a waste-heat steam generator 6 through which the hot exhaust gas of the gas turbine, not illustrated, flows. The steam turbine 3 is composed of a high-pressure part 7, of a medium-pressure part 8 and of a low-pressure part 9.

The waste-heat steam generator 6 comprises a condensate preheater 10 which can be fed on the inlet side with condensate from the condenser 5 via a condensate line 11 into which a condensate pump unit 12 is connected. The condensate preheater 10 is connected on the outlet side, on the one hand, via a first condensate branch line 13 to a low-pressure stage 14, assigned to the low-pressure part 9 of the steam turbine 3, of the water/steam circuit and, on the other hand, via a second condensate branch line 15 to a feed-water pump 16. The feed-water pump 16 is connected to the condensate line 11 via a circulating line 18 capable of being shut off by means of a valve 17.

To regulate the temperature of the condensate supplied to the low-pressure stage 14 and the feed-water pump 16, cold condensate from the condensate line 11 can be admixed via a condensate preheater bypass line 21, which can be shut off by means of valves 19, 20, is branched and issues both into the first 13 and into the second 15 condensate branch line, to a condensate which is preheated in the condensate preheater 10.

The feed-water pump 16 brings the preheated condensate flowing out of the condensate preheater 10 to a pressure level suitable for a high-pressure stage 22, assigned to the high-pressure part 7 of the steam turbine 3, of the water/steam circuit. The condensate which is under high pressure can be supplied to the high-pressure stage 22 as feed water via a high-pressure feed-water preheater 23 which is connected on the outlet side to a high-pressure drum 25 via a feed-water line 24.

Moreover, for bypassing the high-pressure feed-water preheater 23, as required, the feed-water pump 16 is connected directly to the high-pressure drum 25 via a bypass line 27 capable of being shut off by means of a valve 26.

The high-pressure drum 25 is connected to a high-pressure evaporator 28, arranged in the waste-heat steam generator 6, for generating water/steam circulation. For the discharge of fresh steam, the high-pressure drum 25 is connected to a high-pressure superheater 29 which is arranged in the waste-heat steam generator 6 and which is connected on the outlet side to the steam inlet 30 of the high-pressure part 7 of the steam turbine 3.

The steam outlet 31 of the high-pressure part 7 of the steam turbine 3 is connected via an intermediate superheater 32 to the steam inlet 33 of the medium-pressure part 8 of the steam turbine 3. Its steam outlet 34 is connected via an overflow line 35 to the steam inlet 36 of the low-pressure part 9 of the steam turbine 3. The steam outlet 37 of the low-pressure part 9 of the steam turbine 3 is connected to the condenser 5, so that a closed water/steam circuit is obtained.

Moreover, a feed-water line 38 branches off from the feed-water pump 16 at a point where the condensate has reached a medium pressure. Said feed-water line is connected to a medium-pressure feed-water preheater 39 which is connected on the outlet side via a feed-water line 40 to a medium-pressure drum 41 of the medium-pressure stage 42.

Moreover, for bypassing the medium-pressure feed-water preheater 39, as required, the medium-pressure extraction of the feed-water pump 16 is connected directly to the medium-pressure drum 41 via a bypass line 44 capable of being shut off by means of a valve 43.

The medium-pressure drum 41 is connected to a medium-pressure evaporator 45, arranged in the waste-heat steam generator 6, to generate water/steam circulation.

For the discharge of medium-pressure fresh steam, the medium-pressure drum 41 is connected to a medium-pressure superheater 46 which, in turn, is connected on the outlet side via a steam line 47 to the intermediate superheater 32 and therefore to the steam inlet 33 of the medium-pressure part 8 of the steam turbine 3.

The low-pressure stage 14 of the waste-heat steam generator 6 comprises a low-pressure drum 48 which is connected to a low-pressure evaporator 49, arranged in the waste-heat steam generator 6, to generate water/steam circulation.

For the discharge of low-pressure fresh steam, the low-pressure drum 48 is connected to the overflow line 35 via a low-pressure superheater 50 and a steam line 51.

In the exemplary embodiment of the invention, shown in FIG. 1, a degasser 52 is connected into the feed-water stream to the low-pressure drum 48. The arrangement of the degasser 52 may in this case also take place in integrated form, that is to say it may be connected firmly to the low-pressure drum 48, for example be placed on it, but it may also be constructed as a separate tank next to the low-pressure drum 48.

In order to achieve a higher capacity of the degasser 52 during degassing operation, the steam production of the low-pressure evaporator 49 is increased in a controlled way in that heat is displaced in the waste-heat steam generator 6. For this purpose, either the feed-water preheater bypass line 44 in the medium-pressure stage 42 or the feed-water preheater bypass line 27 in the high-pressure stage 22 or else both feed-water preheater bypass lines 44, 27 may be opened. Due to lower heat extraction in the region of the medium-pressure or high-pressure stages 44, 22, hotter smoke gas arrives at the condensate preheater 10 and thus allows greater heating of the condensate, with the result that a larger quantity of water or steam can be degassed.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1-6. (canceled)

7. A method for operating a gas and steam turbine system, comprising; providing an associated waste-heat steam generator, utilizing heat contained in the expanded working medium of an associated gas turbine for the generation of steam for an associated steam turbine with at least one low-pressure part and one high-pressure part, the low-pressure part being assigned in the waste-heat steam generator a low-pressure stage with a low-pressure drum,
degassing gases dissolved in the water or steam essentially of steam for the low-pressure part from the low-pressure drum, and,
regulating degassing, steam production in the low-pressure drum being varied in that heat is displaced inside the waste-heat steam generator, wherein the heat in the waste-heat steam generator is displaced in that less heat is extracted from the working medium in a medium-pressure stage or high-pressure stage of the gas and steam turbine system as a result of the opening of a feed-water preheater bypass line.

8. The method as claimed in claim 7, further comprising degassing only a steam quantity required for the low-pressure part of the steam turbine.

9. The method as claimed in claim 7, further comprising degassing less than 30%, of a steam quantity produced in the gas and steam turbine system.

10. The method as claimed in claim 7, further comprising degassing operation taking place by the regulation of the temperature of the low-pressure feed water.

11. The method as claimed in claim 10, further comprising for the regulation of temperature, admixing cold condensate from a condensate preheater bypass line to a condensate preheated in the condensate preheater.

12. The method as claimed in claim 9, further comprising degassing less than 20%, of a steam quantity produced in the gas and steam turbine system.
